(19) United States
(12) Patent Application Publication
(10) Pub. No.: US 2006/0103250 A1
(43) Pub. Date: May 18, 2006

(54) Magnetic motor axle assembly

(76) Inventor: James Morris, Hollywood, FL (US)

Correspondence Address: GOLD & RIZVI, P.A., 600 N. PINE ISLAND ROAD, SUITE 450, PLANTATION, FL, 33324-1311, US

(21) Appl. No.: 11/026,876

(22) Filed: Dec. 30, 2004

Related U.S. Application Data
(63) Continuation-in-part of application No. 10/943,178, filed on Sep. 16, 2004.

(51) Int. Cl. H02K 21/00; H02K 21/12

(52) U.S. Cl. 310/152; 310/156.25; 310/156.18

(57) ABSTRACT

A magnetic motor axle assembly for magnetically augmenting the rotational driving efficiency of a typically electric motor is disclosed. The magnetic motor axle assembly includes a housing and multiple housing magnets provided in the housing. An elongated rotor assembly is rotatably mounted in the housing, and multiple rotor magnets are provided on the rotor assembly. A typically electric motor drivingly engages the rotor assembly. As the rotor assembly rotates in the housing, the housing magnets magnetically repel the respective rotor magnets to augment the torque of the rotor assembly and enhance the rotational driving efficiency of the motor. A fan or other object is drivingly engaged by the rotor assembly.

### CROSS-REFERENCE TO RELATED APPLICATIONS

This is a continuation-in-part of U.S. application Ser. No. 10/943,178, filed Sep. 16, 2004, which application is herein incorporated by reference in its entirety.

### FIELD OF THE INVENTION

The present invention relates generally to motor axle assemblies. More particularly, the present invention relates to a novel magnetic motor axle assembly which is capable of augmenting the rotational driving efficiency of an electric motor in a variety of applications.

### DESCRIPTION OF THE PRIOR ART

Motor axle assemblies are used in a variety of applications to transmit rotation from an electric motor to an object to be rotated, such as a fan, for example. In many instances, the motor directly engages a drive shaft which, in turn, directly engages the object. In such an arrangement, the motor is the only source of the rotational driving force which rotates the object.

In the conventional motor axle assembly, the drive shaft typically extends through bearings provided in a support frame: As the drive shaft rotates against the bearings, some of the rotational energy of the drive shaft is lost through friction. Moreover, the fan or other object typically encounters air resistance or other drag forces which offer rotational resistance during operation. This leads to the expenditure of excess energy by the electric motor, since the electric motor must increase rotation of the drive shaft in order to maintain the desired rotational speed of the object.

Accordingly, there is a need for a magnetic motor axle assembly which can be used in an electric fan or other device to enhance the rotational driving efficiency of a fan or other object to which the assembly is attached by at least partially overcoming the frictional and drag forces during rotation of the fan or other object.

### SUMMARY OF THE INVENTION

The invention is directed to a magnetic motor axle assembly which can be adapted to connect a typically electric motor to a fan or other object to enhance the rotational driving efficiency of the electric motor during rotation of the fan or other object. The magnetic motor axle assembly includes an elongated housing which is mounted on a support base that may be free-standing or attachable to a support surface. Multiple, spaced-apart housing magnets are seated in respective magnet seats provided in the housing. An elongated rotor assembly is rotatably mounted in the housing and includes a terminal axle segment which extends from one end of the housing. A drive end segment of the rotor assembly extends from the opposite end of the housing, and an electric fan or other object is mounted on the drive end segment. An electric motor engages the drive end segment of the rotor assembly. Multiple rotor magnets are provided on the rotor assembly in spaced-apart relationship to each other and are arranged around the circumference of the rotor assembly. The rotor magnets in the rotor assembly correspond in number and position to the respective housing magnets in the housing and are of the same polarity as the housing magnets. Accordingly, as the electric motor rotates the rotor assembly, the rotor magnets on the rotor assembly are rotated adjacent to and then beyond the respective stationary housing magnets on the housing. Simultaneously, the rotor magnets are repelled by the housing magnets, thus imparting additional torque to the rotor assembly, which transmits this torque to the fan or other object. Therefore, the rotational drive efficiency of the electric motor in rotating the fan or other object is enhanced.

In one general aspect of the present invention, a magnetic motor axle assembly is provided for enhancing the rotational drive efficiency of an electric motor. The magnetic motor axle assembly comprises:

a housing;

multiple stationary housing magnets seated in the housing;

an elongated rotor assembly rotatably mounted in the housing;

multiple rotor magnets provided on the rotor assembly and having a polarity which is the same as that of the housing magnets for transiently interfacing with the respective housing magnets;

a motor drivingly engaging the rotor assembly; and

an object drivingly engaged by the rotor assembly for rotation by the rotor assembly responsive to operation of the motor.

In a further aspect of the present invention, at least one magnetic disk assembly is provided on the rotor assembly to augment the magnetic rotation effect facilitated by the housing magnets and rotor magnets.

In yet another aspect of the present invention, a pair of magnetic disk assemblies is provided on the rotor assembly to augment the magnetic rotation effect of the housing magnets and rotor magnets.

In another aspect of the present invention, each magnetic disk assembly includes multiple stationary magnets seated in the housing; a magnetic disk mounted on the rotor assembly; and multiple disk magnets seated in the magnetic disk and having a polarity which is the same as that of the respective stationary magnets, such that the stationary magnets in the housing sequentially repel the respective disk magnets in the magnetic disk to impart additional torque to the rotor assembly as the motor rotates the rotor assembly.

In a still a further aspect of the present invention, a fan is mounted on the axle assembly for rotation by the electric motor through the axle assembly.

In yet another aspect of the present invention, the housing is mounted on a support base which may be free-standing.

These and other aspects, features, and advantages of the present invention will become more readily apparent from the attached drawings and the detailed description of the preferred embodiments, which follow.

### BRIEF DESCRIPTION OF THE DRAWINGS

The preferred embodiments of the invention will hereinafter be described in conjunction with the appended drawings provided to illustrate and not to limit the invention, where like designations denote like elements, and in which:

FIG. 1 is an exploded perspective view of a magnetic motor axle assembly according to the present invention;

FIG. 2 is a partially exploded perspective view of a rotor assembly element of a magnetic motor axle assembly according to the present invention;

FIG. 3 is a perspective view of the rotor assembly element of the magnetic motor axle;

FIG. 4 is a side view of the rotor assembly shown in FIG. 3;

FIG. 5 is a cross-sectional view of the rotor assembly, taken along section lines 5-5 in FIG. 4;

FIG. 6 is a cross-sectional view of the rotor assembly, taken along section lines 6-6 in FIG. 4;

FIG. 7 is a cross-sectional view of the rotor assembly, taken along section lines 7-7 in FIG. 4;

FIG. 8 is a cross-sectional view of the rotor assembly, taken along section lines 8-8 in FIG. 4;

FIG. 9 is a cross-sectional view of the rotor assembly, taken along section lines 9-9 in FIG. 4;

FIG. 10 is an exploded perspective view of a magnetic disk assembly of the magnetic motor axle assembly;

FIG. 11 is a perspective view of a magnetic disk element of the magnetic disk assembly shown in FIG. 10;

FIG. 12 is a front view of the magnetic disk shown in FIG. 11, with interior magnet seats and retaining ring grooves shown in phantom;

FIG. 13 is a side view of the magnetic disk;

FIG. 14 is a cross-sectional view of the magnetic disk, taken along section lines 14-14 in FIG. 13;

FIG. 15 is a longitudinal sectional view of a housing element of the magnetic motor axle, taken along section lines 15-15 in FIG. 18;

FIG. 16 is a perspective view of the housing element shown in FIG. 15;

FIG. 17 is an end view of the housing;

FIG. 18 is a side view of the housing;

FIG. 19 is a transverse sectional view of the housing, taken along section lines 19-19 in FIG. 18; and

FIG. 20 is a transverse sectional view of the housing, taken along section lines 20-20 in FIG. 18.

### DETAILED DESCRIPTION OF THE PREFERRED EMBODIMENTS

Shown throughout the Figures, the present invention is generally directed to a magnetic motor axle assembly which is effective in augmenting the rotational drive efficiency of a typically electric motor in a variety of applications, such as in the rotation of a fan, for example. The magnetic motor axle assembly incorporates a simple design which magnetically augments the torque of an electric-powered or other motor to partially offset effects due to friction and drag and enhance the performance capabilities of the motor.

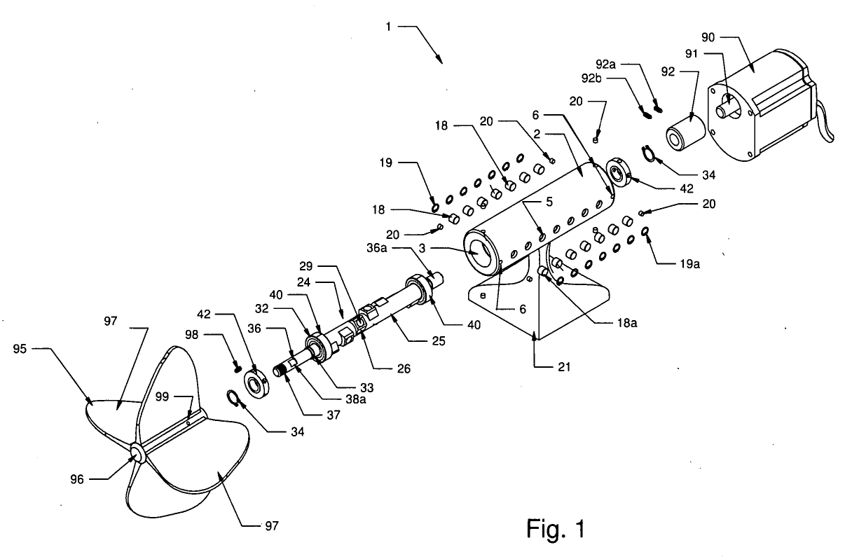

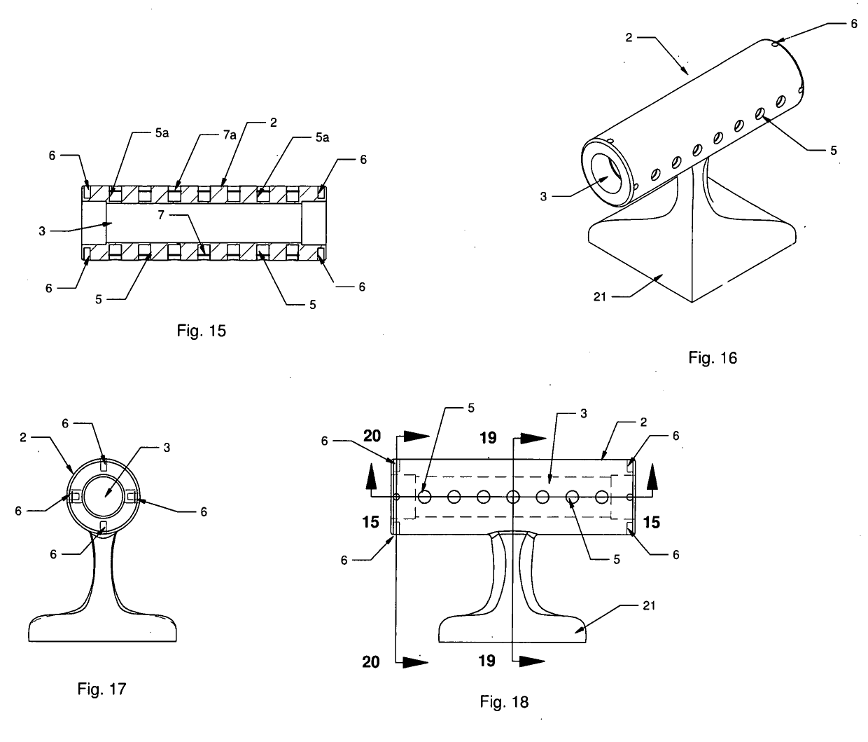

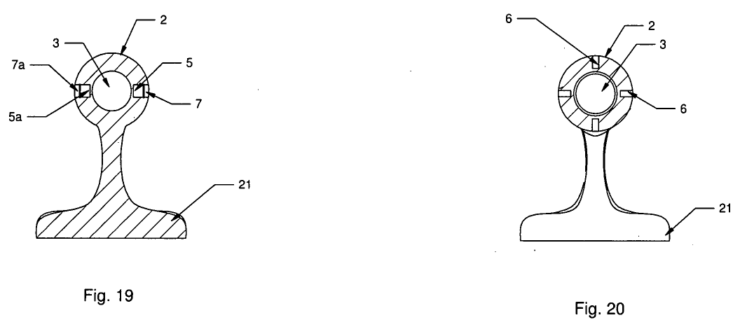

Referring initially to FIGS. 1 and 15-20 of the drawings, a preferred embodiment of the magnetic motor axle assembly of the present invention is generally indicated by reference numeral 1. As illustrated in the exploded view of FIG. 1, the magnetic motor axle assembly 1 includes an elongated housing 2 which is traversed by a housing bore 3. The housing 2 may be mounted on a housing base 21 which may be self-standing on a flat surface, for example. As illustrated in FIG. 15, multiple housing magnet seats 5 extend into the housing 2, in spaced-apart relationship to each other along the longitudinal axis thereof, and communicate with the housing bore 3. Each of the housing magnet seats 5 is circumscribed by a retaining ring groove 7. In like manner, multiple housing magnet seats 5a, each of which is circumscribed by a retaining ring groove 7a, extend through the housing 2 in spaced-apart relationship to each other and communicate with the housing bore 3. The housing magnet seats 5a are aligned with and disposed across the housing bore 3 in substantially diametrically-opposed relationship to the respective housing magnet seats 5.

As illustrated in FIG. 1, a housing magnet 18, which may have a generally cylindrical configuration, is seated in each housing magnet seat 5. By way of example, the present inventor has been successful using Neodymium Disc permanent magnets manufactured by Miami Magnet Company of Miami, Fla. A retaining ring 19 typically snaps into the retaining ring groove 7 in each housing magnet seat 5 to retain the housing magnets 18 in the respective housing magnet seats 5. In like manner, a housing magnet 18a is seated in each housing magnet seat 5a which is located opposite each corresponding housing magnet seat 5. A retaining ring 19a typically snaps into the retaining ring groove 7a in each housing magnet seat 5a to retain the housing magnets 18a in the respective magnet seats 5a. It is understood that alternative techniques known by those skilled in the art, other than or in addition to the retaining rings 19, 19a, can be used to retain the housing magnets 18, 18a in the respective housing magnet seats 5, 5a.

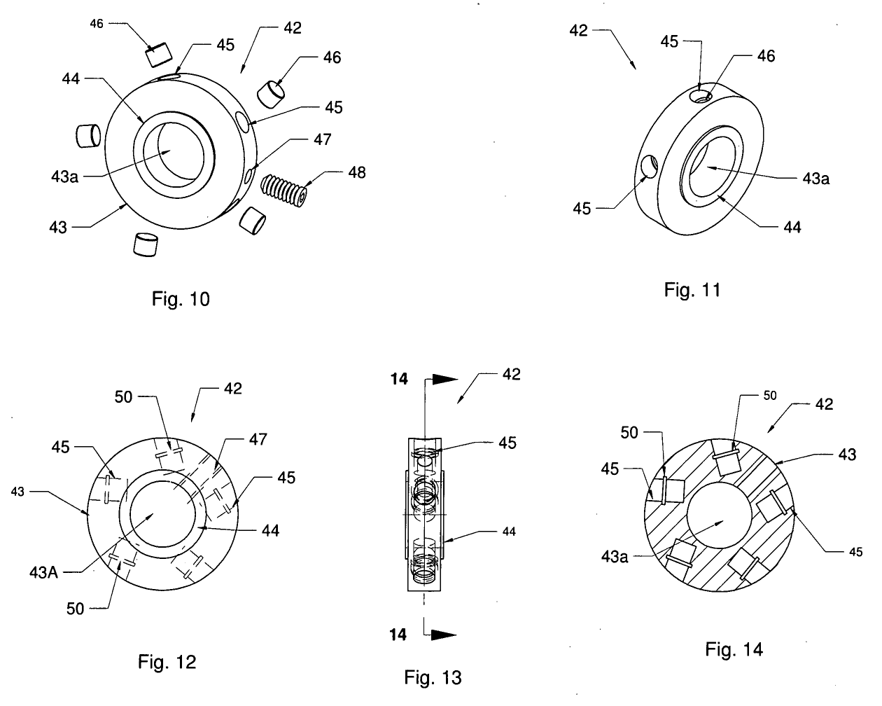

As illustrated in FIGS. 1 and 15, in addition to the housing magnet seats 5, 5a, multiple disk magnet seats 6 may be provided in the end regions of the housing 2. The disk magnet seats 6 are spaced from each other around the circumference of the housing 2. As illustrated in FIGS. 17 and 20, in a typical configuration, first and second pairs of the disk magnet seats 6 may be disposed in diametrically-opposed relationship with respect to each other across the housing bore 3. However, it will be understood that any number of the disk magnet seats 6 may be provided in the housing 2 in any desired relationship with respect to each other. Access ports (not illustrated) may also be provided extending completely through each of the end regions of the housing 2, offset from the magnet seats 6. The access ports are sized and oriented to enable access to the set screws 48 (FIG. 10) of the magnetic disk assemblies 42, using an Allen-type wrench or similar tool, in order to facilitate tightening and loosening of the set screws 48 against the flats 49 of rotor assembly axle segments 36. As illustrated in FIG. 1, a stationary magnet 20 is seated in each disk magnet seat 6. The stationary magnets 20 may be retained in the respective disk magnet seats 6 using a retaining ring (not illustrated), for example, as heretofore described with respect to the housing magnets 18 and 18a, and/or by using glue or other fastening technique known to those skilled in the art.

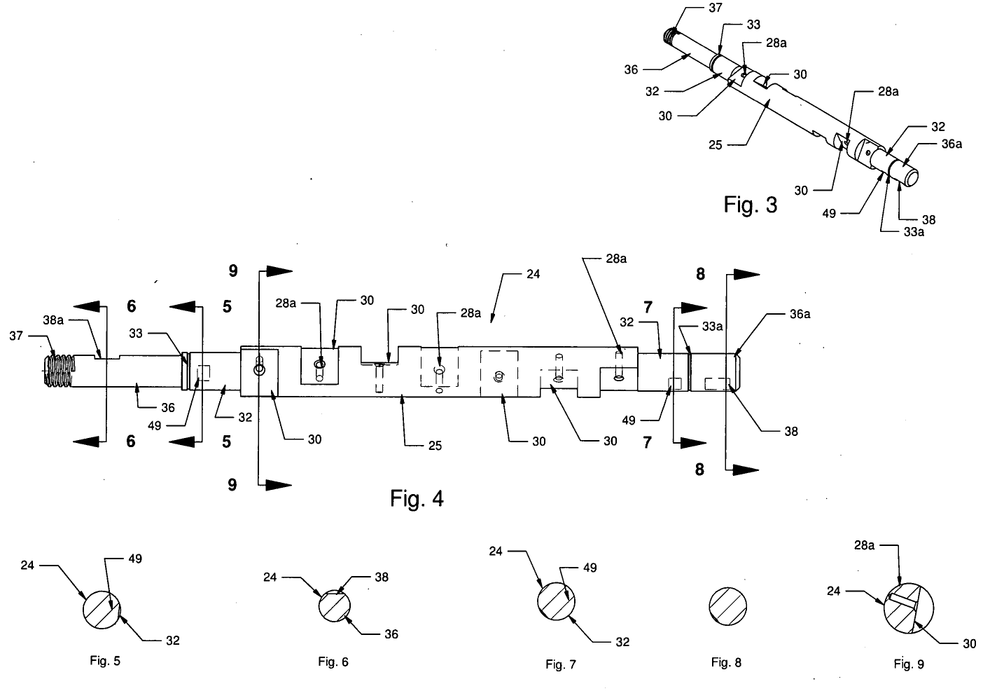

Referring next to FIGS. 1-9 of the drawings, a rotor assembly 24 is rotatably mounted in the housing bore 3 of the housing 2. The rotor assembly 24 includes an elongated central segment 25, disk mount segments 32 which extend from the respective ends of the central segment 25, a terminal axle segment 36 which extends from one of the disk mount segments 32, and a drive end segment 36a which extends from the other disk mount segment 32. The disk mount segments 32 are smaller in diameter than the central segment 25, and the axle segment 36 is smaller in diameter than the disk mount segments 32. The drive end segment 36a is typically about the same in diameter as the disk mount segments 32. As illustrated in FIG. 3, a retaining ring groove 33 circumscribes the disk mount segment 32, adjacent to the junction of the disk mount segment 32 with the axle segment 36. A second retaining ring groove 33a typically circumscribes the disk mount segment 32 adjacent to the drive end segment 36a. A screw flat 49 is provided in each disk mount segment 32. A set screw flat 38 is typically provided in the drive end segment 38, and a set screw flat 38a is typically provided in the axle segment 36. Multiple axle threads 37 are provided in the axle segment 36, adjacent to the end thereof.

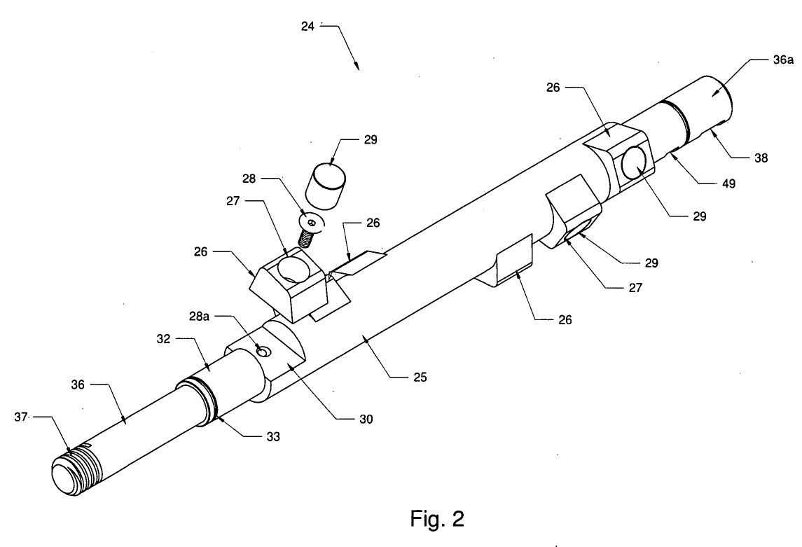

Multiple, flat lobe seats 30 are provided in the central segment 25, in spaced-apart relationship to each other along the longitudinal axis of the central segment 25. From one end to the opposite end of the central segment 25, the lobe seats 30 are progressively arranged in a staggered array around the circumference of the central segment 25. A cap screw opening 28a extends into the center of each lobe seat 30. As illustrated in FIG. 2, a magnet lobe 26 is seated in each lobe seat 30 typically using a cap screw 28, as will be hereinafter further described. Each magnet lobe 26 typically includes a magnet opening 27. A cap screw opening (not illustrated) extends through the magnet lobe 26, at the bottom of the magnet opening 27. Each magnet lobe 26 is seated in the corresponding lobe seat 30. A lobe mount cap screw 28 is extended through the cap screw opening (not illustrated) in the bottom of the magnet lobe 26 and threaded into the underlying cap screw opening 28a in the lobe seat 30 to secure each magnet lobe 26 to the rotor assembly 24. A rotor magnet 29 is seated in the magnet opening 27 of each magnet lobe 26. The rotor magnet 29 may be retained in the magnet opening 27 using a retaining ring (not illustrated) or other retaining technique known by those skilled in the art.

As illustrated in FIG. 1, a sealed bearing 40, having a central bearing opening (not illustrated), is mounted on each disk mount segment 32 of the rotor assembly 24. A magnetic disk assembly 42, the structural details of which will be hereinafter described, is mounted on each of the disk mount segments 32, adjacent to the corresponding sealed bearing 40. Retaining rings 34 snap into the retaining ring grooves 33, 33a of the respective disk mount segments 32 to retain each sealed bearing 40 and adjacent magnetic disk assembly 42 on the corresponding disk mount segment 32.

Referring next to FIGS. 10-14 of the drawings, each magnetic disk assembly 42 includes an annular disk 43 having a central disk opening 43a. Preferably, annular disk 43 is constructed from either Brass (i.e., Copper and Zinc) or Bronze (i.e., Copper and Tin). An annular disk bushing 44 is provided in the disk opening 43a. Multiple magnet seats 45 extend into the outer surface of the disk 43, in circumferentially-spaced relationship with respect to each other. As illustrated in FIG. 12, a set screw opening 47 extends through the disk 43 and disk bushing 44 and communicates with the disk opening 43a. As illustrated in FIGS. 12 and 14, a retaining ring groove 50 typically circumscribes each magnet seat 45.

As illustrated in FIG. 11, a disk magnet 46 is seated in each magnet seat 45. A retaining ring (not illustrated) snaps into each retaining ring groove 50 to retain each disk magnet 46 in the corresponding magnet seat 45. Alternative techniques may be used in addition to or instead of the retaining rings to secure the disk magnets 46 in the respective magnet seats 45. Each magnetic disk assembly 42 is secured to the corresponding disk mount segment 32 of the rotor assembly 42 by threading a set screw 48 into the set screw opening 47 and tightening the set screw 48 against the set screw flat 49 (FIG. 4) provided in each disk mount segment 32. The retaining rings 34 which snap into the retaining ring grooves 33, 33a of the respective disk mount segments 32 prevent each sealed-bearing 40 and magnetic disk assembly 42 pair from inadvertently becoming dislocated from the disk mount segment 32 and sliding onto the corresponding adjacent axle segment 36 or drive end segment 36a.

As illustrated in FIG. 1, a motor 90, which is typically though not necessarily an electric motor, from which extends a motor drive shaft 91, drivingly engages the drive end segment 36a of the rotor assembly 24, typically through a drive bushing 92. The drive bushing 92 may be secured on the motor drive shaft 91 by threading a set screw 92a through a set screw opening (not illustrated) extending radially through the drive bushing 92 and tightening the set screw 92a against a screw flat (not illustrated) provided in the motor drive shaft 91. The drive bushing 92 may in like manner be secured on the drive end segment 36a of the rotor assembly 24 by, for example, threading a set screw 92b through a set screw opening (not illustrated) extending radially through the drive bushing 92 and tightening the set screw 92b against the set screw flat 38 (FIG. 4) provided in the drive end segment 36a. It is understood that the motor drive shaft 91 can drivingly engage the drive end segment 36a using any of a variety of alternative techniques known by those skilled in the art.

As illustrated in FIG. 1, in a preferred embodiment of the magnetic motor axle assembly 1, a fan 95 is mounted on the axle segment 36 of the rotor assembly 24. However, it is understood that the magnetic motor axle assembly 1 may alternatively be adapted to rotate any type of object mounted on the axle segment 36. The fan 95 typically includes an elongated, generally cylindrical fan hub 96 which is drivingly engaged by the axle segment 36 of the rotor assembly 24. Multiple fan blades 97 extend outwardly from the fan hub 96.

Typically, interior hub threads (not illustrated) are provided inside the fan hub 96. The hub threads engage the exterior axle threads 37 on the end of the axle segment 36 to mount the fan 95 on the rotor assembly 24. Furthermore, a set screw 98 may be threaded through a set screw opening 99 provided in the fan hub 96 and tightened against the set screw flat 38a in the axle segment 36 to further secure the fan 95 on the rotor assembly 24. However, it is understood that the fan 95 may be mounted on the rotor assembly 24 using any of a variety of alternative techniques known by those skilled in the art.

In the assembled magnetic motor axle 1, the rotor assembly 24 extends through the housing bore 3 in the housing 2. The sealed bearings 40 fixedly engage the interior surface of the housing 2 in the housing bore 3 such that the rotor assembly 24 is capable of rotating freely in the bearing openings (not illustrated) of the respective sealed bearings 40. The rotor magnets 29 of the rotor assembly 24 are aligned with the respective housing magnets 18 and 18a of the housing 2. Accordingly, as the electric motor 90 rotates the rotor assembly 24 the housing bore 3, the rotor magnets 29 repeatedly rotate past the respective stationary housing magnets 18 and then the respective housing magnets 18a. Because the polarity of the rotor magnets 29 is the same as that of the housing magnets 18 and housing magnets 18a, the housing magnets 18 and housing magnets 18a repel the rotor magnets 29 each time the rotor magnets 29 are rotated into proximity with the housing magnets 18 and housing magnets 18a. This magnetic repulsive effect imparts additional torque to the rotor assembly 24. The rotor assembly 24, in turn, transmits torque to the fan 95, assisting the electric motor 90 in rotating the fan 95. Consequently, a reduced power requirement is imposed on the electric motor 90, such that the fan 95 can be operated using a lower-powered electric motor 90 than would normally be the case.

In use of the invention, the housing base 21 may be supported in a free-standing position on a support surface (not illustrated). Alternatively, the housing base 21 may be bolted or otherwise attached to the support surface according to techniques known by those skilled in the art. As the electric motor 90 rotates the rotor assembly 24 typically through the drive bushing 92, the rotor assembly 24 rotates the fan 95. Simultaneously, the rotor magnets 29 repeatedly rotate past the respective stationary housing magnets 18 and 18a, and thus, the housing magnets 18 and 18a, respectively, to successively repel the rotor magnets 29. Accordingly, the magnetic repulsive effect imparts torque on the rotor assembly 24 which, in turn, transmits torque to the fan 95. It will be appreciated by those skilled in the art that, due to the staggered arrangement of the rotor magnets 29 about the circumference of the rotor assembly 24, the rotor magnets 29 are sequentially repelled by the respective housing magnets 18 and 18a during rotation of the rotor assembly 24. Therefore, one of the rotor magnets 29 is constantly being repelled by a corresponding housing magnet 18 or 18a as the motor 90 rotates the rotor assembly 24. This provides a continuous application of torque to the rotor assembly 24, and thus, to the fan 95 as long as the electric motor 90 rotates the rotor assembly 24.

The torque applied to the fan 95 by the housing magnets 18, 18a and rotor magnets 29 is augmented by the magnetic disc assemblies 42. Accordingly, as each magnetic disk assembly 42 rotates on the corresponding disk mount segment 32 of the rotor assembly 24, the disk magnets 46 of the magnetic disk assembly 42 sequentially rotate adjacent to and beyond the stationary magnets 20 seated in the respective disk magnet seats 6 of the housing 2. The stationary magnets 20 repel the disk magnets 46, thus applying torque to the magnetic disk assembly 42. The magnetic disk assembly 42, in turn, transmits torque to the rotor assembly 24, thereby augmenting the magnetic torque applied to the rotor assembly 24 by the housing magnets 18, 18a and rotor magnets 29.

While the preferred embodiments of the invention have been described above, it will be recognized and understood that various modifications can be made in the invention and the appended claims are intended to cover all such modifications which may fall within the spirit and scope of the invention.

What is claimed is:

1. A magnetic motor axle assembly, comprising:
a housing;
an elongated rotor assembly rotatably carried by said housing;
a plurality of rotor magnets carried by said rotor assembly;
a plurality of housing magnets carried by said housing for magnetically repelling said plurality of rotor magnets, respectively;
a motor drivingly engaging said rotor assembly; and
an object drivingly engaged by said rotor assembly for rotation by said motor.

2. The magnetic motor axle assembly of claim 1 further comprising at least one magnetic disk assembly having a plurality of disk magnets carried by said rotor assembly and a plurality of stationary magnets carried by said housing for magnetically repelling said plurality of disk magnets, respectively.

3. The magnetic motor axle assembly of claim 2 wherein said at least one magnetic disk assembly comprises a pair of magnetic disk assemblies.

4. The magnetic motor axle assembly of claim 2 wherein said at least one magnetic disk assembly comprises a disk carried by said rotor assembly and wherein said plurality of disk magnets is carried by said disk.

5. The magnetic motor axle assembly of claim 1 wherein said object comprises a fan.

6. The magnetic motor axle assembly of claim 5 further comprising at least one magnetic disk assembly having a plurality of disk magnets carried by said rotor assembly and a plurality of stationary magnets carried by said housing for magnetically repelling said plurality of stationary magnets, respectively.

7. The magnetic motor axle assembly of claim 6 wherein said at least one magnetic disk assembly comprises a pair of magnetic disk assemblies.

8. The magnetic motor axle assembly of claim 7 wherein said pair of magnetic disk assemblies each comprises a disk carried by said rotor assembly and wherein said plurality of disk magnets is carried by said disk.

9. A magnetic motor axle assembly, comprising:
a housing;
an elongated rotor assembly rotatably carried by said housing;
a plurality of rotor magnets carried by said rotor assembly;
a first set of housing magnets carried by said housing on a first side of said rotor assembly and a second set of housing magnets carried by said housing on a second side of said rotor assembly for magnetically repelling said plurality of rotor magnets, respectively;
a motor drivingly engaging said rotor assembly; and
an object drivingly engaged by said rotor assembly for rotation by said motor.

10. The magnetic motor axle assembly of claim 9 further comprising at least one magnetic disk assembly having a plurality of disk magnets carried by said rotor assembly and a plurality of stationary magnets carried by said housing for magnetically repelling said plurality of disk magnets, respectively.

11. The magnetic motor axle assembly of claim 10 wherein said at least one magnetic disk assembly comprises a pair of magnetic disk assemblies.

12. The magnetic motor axle assembly of claim 11 wherein said pair of magnetic disk assemblies each comprises a disk carried by said rotor assembly and wherein said plurality of disk magnets is carried by said disk.

13. The magnetic motor axle assembly of claim 9 wherein said object comprises a fan.

14. The magnetic motor axle assembly of claim 13 further comprising at least one magnetic disk assembly having a plurality of disk magnets carried by said rotor assembly and a plurality of stationary magnets carried by said housing for magnetically repelling said plurality of stationary magnets, respectively.

15. The magnetic motor axle assembly of claim 14 wherein said at least one magnetic disk assembly comprises a pair of magnetic disk assemblies.

16. The magnetic motor axle assembly of claim 15 wherein said pair of magnetic disk assemblies each comprises a disk carried by said rotor assembly and wherein said plurality of disk magnets is carried by said disk.

17. A magnetic motor axle assembly, comprising:
a housing base;
a housing carried by said housing base;
an elongated, generally cylindrical rotor assembly rotatably carried by said housing;
a plurality of spaced-apart rotor magnets carried by said rotor assembly, said rotor magnets arranged in a generally staggered relationship to each other around a circumference of said rotor assembly;
a plurality of housing magnets carried by said housing for magnetically repelling said plurality of rotor magnets, respectively;
a motor drivingly engaging said rotor assembly; and
an object drivingly engaged by said rotor assembly.

18. The magnetic motor axle assembly of claim 17 further comprising at least one magnetic disk assembly having a plurality of disk magnets carried by said rotor assembly and a plurality of stationary magnets carried by said housing for magnetically repelling said plurality of disk magnets, respectively.

19. The magnetic motor axle assembly of claim 18 wherein said at least one magnetic disk assembly comprises a pair of magnetic disk assemblies.

20. The magnetic motor axle assembly of claim 19 wherein said object comprises a fan.

21. The magnetic motor axle assembly of claim 20 wherein said rotor assembly comprises an elongated central segment, a pair of disk mount segments extending from said central segment and a pair of axle segments extending from said pair of disk mount segments, respectively; and wherein said plurality of rotor magnets is carried by said central segment, said pair of magnetic disk assemblies is carried by said pair of disk mount segments, respectively, and said at least one drive wheel and said free wheel are carried by said pair of axle segments, respectively.

22. The magnetic motor axle assembly of claim 17 wherein said plurality of housing magnets comprises a first set of housing magnets carried by said housing on a first side of said rotor assembly and a second set of housing magnets carried by said housing on a second side of said rotor assembly.

23. The magnetic motor axle assembly of claim 22 further comprising a pair of magnetic disk assemblies each having a plurality of disk magnets carried by said rotor assembly and a plurality of stationary magnets carried by said housing for magnetically repelling said plurality of disk magnets, respectively.

24. The magnetic motor axle assembly of claim 23 wherein said object comprises a fan.

25. The magnetic motor axle assembly of claim 24 wherein said rotor assembly comprises an elongated central segment, a pair of disk mount segments extending from said central segment and a pair of axle segments extending from said pair of disk mount segments, respectively; and wherein said plurality of rotor magnets is carried by said central segment, said pair of magnetic disk assemblies is carried by said pair of disk mount segments, respectively, and said at least one drive wheel and said free wheel are carried by said pair of axle segments respectively.
